(19) United States
(12) Patent Application Publication
(10) Pub. No.: US 2026/0142103 A1
(43) Pub. Date: May 21, 2026

(54) Remote control mechanism and remote controller

(71) Applicants: CHING-HSIUNG LIN, Taiwan (CN); Kemflo (Nanjing) Environmental Technology Co., Ltd., Nanjing (CN); Kemflo International Co., Ltd., Taiwan (CN); Taiga Global Inc., Seongnam-si (KR)

(72) Inventors: Weiqiang LIU, Nanjing (CN); Hao ZHANG, Nanjing (CN); Haipeng ZHOU, Nanjing (CN); Xuelin FAN, Nanjing (CN); Won Seok LEE, Seongnam-si (KR)

(73) Assignees: CHING-HSIUNG LIN, Taiwan (CN); Kemflo (Nanjing) Environmental Technology Co., Ltd., Nanjing (CN); Kemflo International Co., Ltd., Taiwan (CN); Taiga Global Inc., Seongnam-si (KR)

(21) Appl. No.: 19/276,051

(22) Filed: Jul. 22, 2025

(30) Foreign Application Priority Data
Nov. 15, 2024 (CN) 202422796186.8

(51) Int. Cl. H01H 21/22; H01F 7/00

(52) U.S. Cl. CPC H01H 21/22; H01F 7/00

(57) ABSTRACT

A remote control mechanism and a remote controller are provided, including a control assembly, a packaging assembly provided with a packaging space to receive the control assembly, and a triggering assembly. The triggering assembly includes a handle, a magnetic member, and a magnetic induction element. The handle is rotatably connected to the packaging assembly, the magnetic member is mounted on the handle, and the magnetic induction element is provided in the packaging space. The handle has a triggering position and an off position. When the handle is located at the triggering position, the magnetic induction element is located out of a magnetic induction area of the magnetic member, and the control assembly generates a control signal. When the handle is switched to the off position, the magnetic induction element is located within the magnetic induction area, and the control assembly stops generating the control signal.

### CROSS-REFERENCE TO THE RELATED APPLICATIONS

This application is based upon and claims priority to Chinese Patent Application No. 202422796186.8, filed on Nov. 15, 2024, the entire contents of which are incorporated herein by reference.

### TECHNICAL FIELD

The present disclosure relates to the technical field of remote controllers, and in particular to a remote control mechanism and a remote controller.

### BACKGROUND

With the development of economy and the improvement of living standards, people have higher requirements for the convenience and operation experience of products. Most of the signal transmitting devices trigger a signal by pressing a switch, which requires a user to approach the product for pressing operation to trigger the signal, resulting in a poor user experience.

In addition, due to the limitations of the electrical and mechanical life of the push-type mechanical switch, the ability of the switch to withstand the current load and the number of times of the switch being turn-on and off, as well as the ability of the switch to withstand the number of times of mechanical movements, are limited. Under frequent operation, the mechanical switch may be damaged due to reaching the life limit, which affects the use experience of the product.

### SUMMARY

Accordingly, it is necessary to provide a remote control mechanism and a remote controller to address a problem of a poor user experience caused by triggering a signal by pressing a switch.

In a first aspect, a remote control mechanism is provided. The remote control mechanism includes a control assembly, a packaging assembly, and a triggering assembly. The control assembly is configured to generate a control signal. The packaging assembly is provided with a packaging space to receive the control assembly. The triggering assembly includes a handle, a magnetic member, and a magnetic induction element. The handle is rotatably connected to the packaging assembly, the magnetic member is mounted on the handle, and the magnetic induction element is provided in the packaging space and is electrically connected to the control assembly. The handle has a triggering position and an off position that are spaced apart. When the handle is located at the triggering position, the magnetic induction element is located out of a magnetic induction area of the magnetic member, and the control assembly generates the control signal. When the handle is switched to the off position, the magnetic induction element is located within the magnetic induction area of the magnetic member, and the control assembly stops generating the control signal.

In one embodiment, the magnetic induction element includes at least one of the group consisting of a Hall element, a coil, a reed switch, a semiconductor magnetoresistive element, and a magnetoresistive element.

In one embodiment, the control assembly includes a substrate, a microcontroller, and a signal transmitter that are provided in the packaging space, the microcontroller and the signal transmitter are both mounted on the substrate, the microcontroller is electrically connected to the signal transmitter, and the microcontroller is configured to control the signal transmitter to generate the control signal when the handle is located at the triggering position.

In one embodiment, the remote control mechanism further includes an input power source mounted on the substrate, and the microcontroller and the signal transmitter are electrically connected to the input power source; or, the microcontroller and the signal transmitter are being electrically connected to an external DC power supply.

In one embodiment, the packaging assembly includes an upper cover and a lower base, the upper cover and the lower base enclose the packaging space, and the control assembly is detachably connected to the lower base.

In one embodiment, a buckle is provided on a side of the upper cover facing the lower base, a side of the lower base facing the upper cover is provided with an engaging groove, and the buckle is engaged in the engaging groove.

In one embodiment, the packaging assembly further includes a sealing ring provided in the packaging space, the sealing ring is sleeved on the control assembly and is assembled in the packaging space in an interference fit.

In one embodiment, the remote control mechanism further includes a reset member mounted on a side of the handle away from the magnetic induction element, when the handle rotates from the off position to the triggering position, the reset member is compressed to enable the handle to have a tendency to rotate toward the off position.

In a second aspect, a remote control mechanism is provided. The remote controller includes a housing provided with an accommodating cavity and the above-mentioned remote control mechanism. The remote control mechanism is at least partially accommodated in the accommodating cavity, the packaging assembly is detachably connected to the housing, and at least a portion of the handle extends out of the accommodating cavity.

In one embodiment, the remote controller includes a plurality of remote control mechanisms, and the plurality of remote control mechanisms are arranged side by side or arranged up and down.

The above-mentioned remote control mechanism enables the magnetic induction element to be located within or out of the magnetic induction area of the magnetic member by switching the handle between the triggering position and the off position. The control signal is triggered when the magnetic induction element is located out of the magnetic induction area of the magnetic member, and the control signal is stopped from being triggered when the magnetic induction element is located within the magnetic induction area of the magnetic member, so as to achieve whether the control signal is triggered or not, thereby avoiding the disadvantages of the service life of a mechanical switch, while improving the use experience of the product.

The details of one or more embodiments of the application are set forth in the accompanying drawings and the description below. Other features, objects, and advantages of the application will be apparent from the description and drawings, and from the claims.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a schematic view of a control assembly according to an embodiment of the present disclosure.

FIG. 2 is an exploded view of a remote control mechanism according to an embodiment of the present disclosure.

FIG. 3 is a cross-sectional view of a remote control mechanism when no control signal is generated according to an embodiment of the present disclosure.

FIG. 4 is a cross-sectional view of a remote control mechanism when a control signal is generated according to an embodiment of the present disclosure.

FIG. 5 is a cross-sectional view of a remote controller according to an embodiment of the present disclosure.

### DESCRIPTION OF REFERENCE NUMERALS

1. Control assembly; 11. Substrate; 12. Signal transmitter; 13. Input power source; 2. Packaging assembly; 21. Upper cover; 211. Buckle; 22. Lower base; 221. Engaging groove; 23. Sealing ring; 3. triggering assembly; 31. magnetic member; 32. Magnetic induction element; 33. Handle; 4. Reset member; 5. Packaging space; 6. Housing; 61. Accommodating cavity; 7. Spray pot.

### DETAILED DESCRIPTION OF THE EMBODIMENTS

In order to make the above objectives, features and advantages of the present disclosure clear and easier to understand, the specific embodiments of the present disclosure are described in detail below in combination with the accompanying drawings. Many specific details are set forth in the following description to facilitate a full understanding of the present disclosure. However, the present disclosure can be implemented in many ways different from those described herein, and those skilled in the art can make similar improvements without departing from the connotation of the present disclosure. Therefore, the present disclosure is not limited by the specific embodiments disclosed below.

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuths or position relationships shown in the attached drawings. These terms are only for the convenience of describing the present disclosure and simplifying the description, rather than indicating or implying that the indicated devices or elements must have the specific azimuths, or be constructed or operated in the specific azimuths, and therefore such terms cannot be understood as limitations of the present disclosure.

In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined.

In the present disclosure, unless otherwise expressly specified and limited, the terms “mount”, “connect”, “couple”, “fix” and the like should be interpreted broadly. For example, the terms can mean fixed connection, detachable connection, or being integrated. The terms can mean mechanical connection or electrical connection. The terms can mean directly connection or indirectly connection through an intermediate medium. The terms can mean connection within two elements or interaction relationship between two elements, unless otherwise expressly limited. For those skilled in the art, the specific meaning of the above terms in the present disclosure should be understood according to the specific situation.

In the present disclosure, unless otherwise expressly specified and limited, a first feature “above” or “below” a second feature may be in direct contact with the second feature, or the first and second features may be in indirect contact through an intermediate medium. Moreover, the first feature “above” the second feature may be right above or obliquely above the second feature, or the first feature may be merely located at a height higher than the second feature. The first feature “below” the second feature may be right below or obliquely below the second feature, or the first feature may be merely located at a height lower than that of the second feature.

It should be noted that when an element is called “fixed to” or “mounted on” another element, it can be directly on another element or there can be an intermediate element. When an element is considered to be “connected” to another element, it can be directly connected to another element or there can be an intermediate element. The terms “vertical”, “horizontal”, “up”, “down”, “left”, “right” and similar expressions used herein are for the purpose of illustration only and do not represent the only ways for implementation.

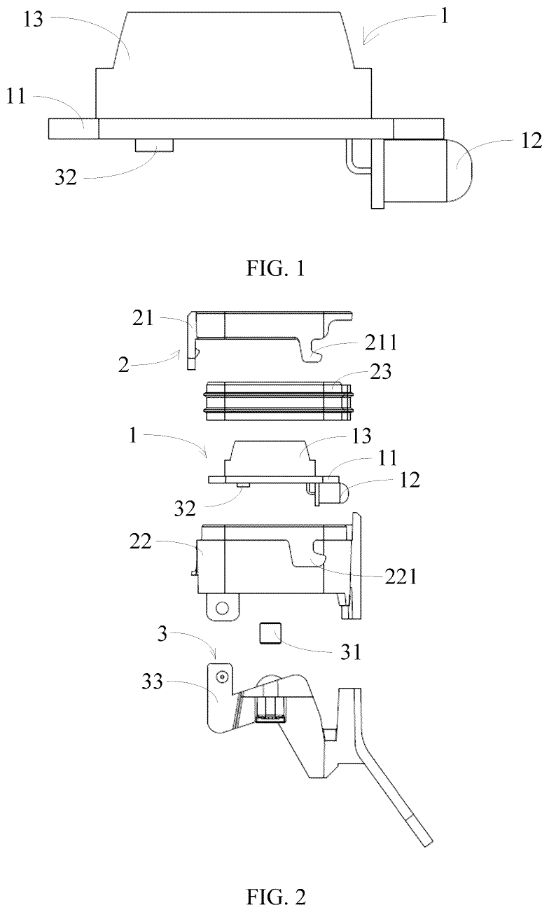

Embodiments of the present disclosure are described in detail below in conjunction with the accompanying FIGS. 1 to 5.

Referring to FIG. 1 and FIG. 2, an embodiment of the present disclosure provides a remote control mechanism. FIG. 1 is a schematic view of a control assembly according to an embodiment of the present disclosure, and FIG. 2 is an exploded view of a remote control mechanism according to an embodiment of the present disclosure.

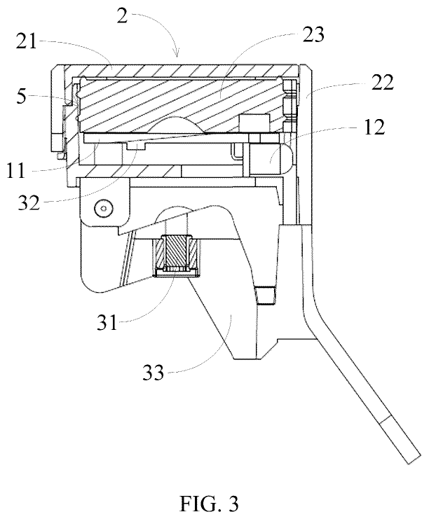

As shown in FIG. 1 and FIG. 2, in some embodiments, a remote control mechanism includes a control assembly 1, a packaging assembly 2, and a triggering assembly 3. The control assembly 1 is capable of generating a control signal when triggered by the triggering assembly 3, so as to remotely control a receiving device. In the embodiment of the present disclosure, the control assembly 1 may be a printed circuit board assembly (PCBA). In addition, referring to FIG. 3, the packaging assembly 2 is provided with a packaging space 5, and the control assembly 1 is accommodated in the packaging space 5 and is surrounded by the packaging assembly 2, so that the control assembly 1 (i.e., an electronic component) can be completely isolated from the triggering assembly 3 (i.e., a mechanical component), and the control assembly 1 has sufficient sealing property and waterproof property to achieve isolation protection for the control assembly 1, thereby prolonging the service life of the control assembly 1.

Specifically, the triggering assembly 3 includes a magnetic member 31, a magnetic induction element 32, and a handle 33. The magnetic member 31 is mounted on the handle 33. One end of the handle 33 is rotatably connected to the packaging assembly 2, and the other end of the handle 33 is used for an operator to toggle. The magnetic induction element 32 is provided in the packaging space 5 and is electrically connected to the control assembly 1.

In the embodiment of the present disclosure, the magnetic member 31 may specifically be a magnet, and the magnetic induction element 32 may specifically be at least one of the group consisting of a Hall element, a coil, a reed switch, a semiconductor magnetoresistive element, and a magnetoresistive element, preferably a Hall element. In some embodiments, the magnetic member 31 is embedded in the handle 33 in an interference fit. In other embodiments, the magnetic member 31 may be fixed to the handle 33 by means of adhesion, screw connection or ultrasonic welding. In yet some embodiments, the magnetic member 31 may be placed into a mold cavity before the handle 33 is injection-molded, so that the magnetic member 31 and the handle 33 are embedded as one after the handle 33 is injection-molded.

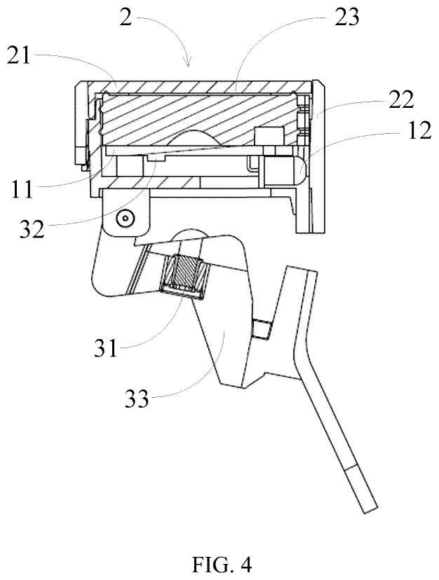

As shown in FIGS. 3 and 4, FIG. 3 is a cross-sectional view of the remote control mechanism when no signal is output according to an embodiment of the present disclosure, and FIG. 4 is a cross-sectional view of the remote control mechanism when a signal is output according to an embodiment of the present disclosure. In some embodiments. An end of the handle 33 for the operator to toggle is defined as a moving end, and an end of the handle 33 rotatably connected to the packaging assembly 2 is defined as a rotating end. The moving end of the handle 33 has a triggering position and an off position that are spaced apart, and both the triggering position and the off position are located on an arc trajectory formed by the moving end rotating around the rotating end.

Driven by an external force, the moving end of the handle 33 can be switched between the triggering position and the off position, so as to drive the magnetic member 31 mounted on the handle 33 to approach or move away from the magnetic induction element 32, so that a magnetic induction area of the magnetic member 31 correspondingly approaches or moves away from the magnetic induction element 32, and the magnetic induction element 32 is located within or out of the magnetic induction area of the magnetic member 31, thereby causing the control assembly 1 connected to the magnetic induction element 32 to generate or stop generating a control signal.

Specifically, as shown in FIG. 4, when the handle 33 is located at the triggering position, the magnetic induction element 32 is located out o the magnetic induction area of the magnetic member 31, the magnetic induction element 32 cannot sense a magnetic field generated by the magnetic member 31, and the control assembly 1 connected to the magnetic induction element 32 generates a control signal. As shown in FIG. 3, when the handle 33 is switched to the off position, the magnetic induction element 32 is located within the magnetic induction area of the magnetic member 31, the magnetic induction element 32 senses the magnetic field generated by the magnetic member 31, and the control assembly 1 connected to the magnetic induction element 32 stops transmitting the control signal.

According to the remote control mechanism of the present disclosure, by rotating of the handle 33, the magnetic induction element 32 can be located within or out of the magnetic induction area of the magnetic member 31. The control signal is triggered when the magnetic induction element 32 is located out of the magnetic induction area of the magnetic member 31, and the control signal is stopped from being triggered when the magnetic induction element 32 is located within the magnetic induction area of the magnetic member 31, so as to achieve whether the control signal is triggered or not, thereby avoiding the disadvantages of the service life of a mechanical switch, while improving the use experience of the product.

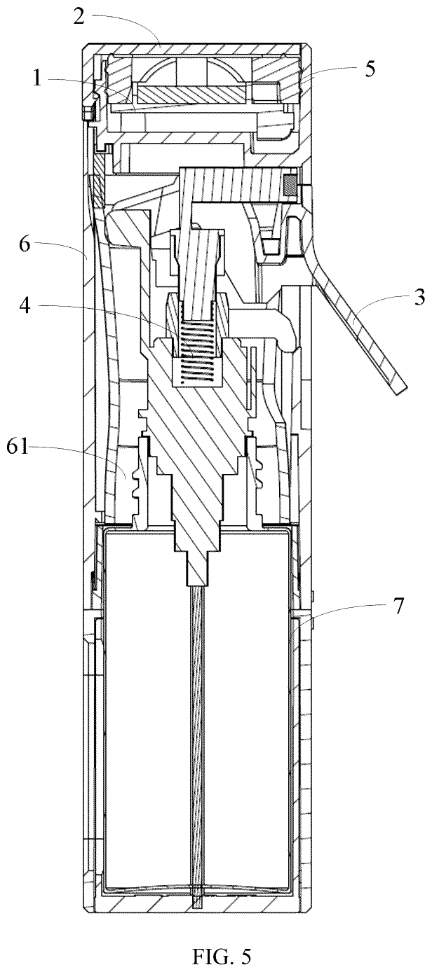

Referring to FIG. 5, FIG. 5 is a cross-sectional view of a remote controller according to an embodiment of the present disclosure. In some embodiments, the remote control mechanism further includes a reset member 4 mounted on a side of the handle 33 away from the magnetic induction element 32.When the moving end of the handle 33 rotates from the off position to the triggering position, the reset member 4 is compressed under the pressure of the handle 33 to enable the moving end to rotate towards the off position, so that when the operator releases the handle 33, the handle 33 is driven by the reset member 4 to return to the off position, thereby further improving the use experience of the product.

Referring to FIG. 1 and FIG. 2, in some embodiments, the packaging assembly 2 includes an upper cover 21 and a lower base 22. The upper cover 21 and the lower base 22 are detachably connected to each other and enclose the packaging space 5. The handle 33 is rotatably connected to the lower base 22 by a rotating shaft. In the embodiment of the present disclosure, a buckle 211 is formed on a side of the upper cover 21 facing the lower base 22. A side of the lower base 22 facing the upper cover 21 is provided with an engaging groove 221. The buckle 211 is engaged in the engaging groove 221 to achieve a detachable connection between the upper cover 21 and the lower base 22.

It should be understood that, in other embodiments, the upper cover 21 and the lower base 22 can also be connected by other means such as bolt connection or adhesion, as long as they can enclose a closed space for receiving the control assembly 1, and the specific connection manner is not limited in the present disclosure.

Further, in some other embodiments, the packaging assembly 2 further includes a sealing ring 23 provided in the packaging space 5. The sealing ring 23 is sleeved on the control assembly 1 and is assembled in the packaging space 5 in an interference fit, so as to achieve complete isolation between the control assembly 1 and the triggering assembly 3, and water is prevented from entering the control assembly 1 from an upper part or a side part of the packaging space 5, so that the control assembly 1 has sufficient sealing property and waterproof property to prolong the service life of the remote control mechanism.

Referring to FIG. 2, in some embodiments, the control assembly 1 includes a substrate 11, a microcontroller, and a signal transmitter 12 that are provided in the packaging space. In the embodiment of the present disclosure, the substrate 11 is a PCB board, the microcontroller is an MCU (Microcontroller Unit). The signal transmitter 12 includes but is not limited to an infrared lamp and a Bluetooth transmitter lamp. The microcontroller and the signal transmitter 12 are both welded to the substrate 11, the microcontroller is electrically connected to the signal transmitter 12, and the microcontroller controls the signal transmitter 12 to generate the control signal when the handle 33 is located at the triggering position.

Specifically, when the magnetic induction element 32 is a Hall element, the magnetic induction element 32 can utilize the Hall effect. When the magnetic induction element 32 is a magnetoresistance element, the magnetic induction element 32 can utilize the magnetoresistance effect. When the magnetic induction element 32 is a magnetic sensor, the magnetic induction element 32 can utilize the magnetic coupling effect. In the embodiment of the present disclosure, when an external magnetic field changes, the magnetic induction element 32 will generate a corresponding electrical signal when located within or out of the magnetic induction area of the magnetic member 31. In one embodiment, taking the magnetic induction element 32 as a Hall element as an example, the magnetic induction area is formed around the magnetic member 31, and the Hall element can generate a corresponding electrical signal by being located within the magnetic induction area.

When the magnetic member 31 rotates along with the handle 33 to be switched to the triggering position, the Hall element is located out of the magnetic induction area of the magnetic member 31. At this time, the Hall element does not generate an electrical signal and is in an open state. When no electrical signal is generated, the microcontroller controls the signal transmitter 12 to transmit a control signal, and the receiving device receives the control signal and performs signal processing.

When the magnetic member 31 rotates along with the handle 33 to be switched to the off position, the Hall element is located within the magnetic induction area of the magnetic member 31. At this time, the Hall element generates an electrical signal and is in a closed state. When an electrical signal is generated, the microcontroller controls the signal transmitter 12 not operate, thereby stopping the generation of the control signal.

Referring to FIG. 1 and FIG. 2, in some embodiments, the remote control mechanism further includes an input power source 13. The input power source 13 is mounted on the substrate 11 and is electrically connected to various components soldered on the substrate 11, so as to supply power to the control assembly 1. In the embodiment of the present disclosure, the input power source 13 may specifically be a battery mounted on the substrate 11, such as a button battery. In other embodiments, the control assembly 1 may alternatively be electrically connected to an external DC power supply, that is, the microcontroller and the signal transmitter 12 can both be electrically connected to the external DC power supply, so as to supply power to the control assembly 1.

Referring to FIG. 1 to FIG. 5, in some embodiments, a remote controller is provided, which includes a housing 6 and the remote control mechanism as described in any of the above embodiments. The housing 6 is provided with an accommodating cavity 61, and the remote control mechanism is at least partially accommodated in the accommodating cavity 61. The upper cover 21 and a lower base 22 of the packaging assembly 2 are detachably connected to the housing 6, respectively, and at least a portion of the handle 33 extends through a side wall of the housing 6 and extends out of the accommodating cavity 61 for operation by an operator.

In the embodiment of the present disclosure, the remote controller is specifically a remote control device triggered by magnetic induction, which is triggered by magnetic induction, thereby avoiding the disadvantage of limited service life of mechanical switches, while also increasing the uniqueness of the product and improving user experience.

In other embodiments, the remote controller includes a plurality of remote control mechanisms, and the plurality of remote control mechanisms are mounted to the housing 6 in a certain order. Similar to the above embodiment, each remote control mechanism is also at least partially accommodated in the accommodating cavity 61, and the moving end of the handle 33 of each remote control mechanism extends out of the accommodating cavity 61. In the embodiment of the present disclosure, for convenience of description, taking FIG. 5 as an example, an extension direction of the housing 6 in FIG. 5 is defined as a height direction, and a radial direction of the housing 6 is defined as a horizontal direction. In some embodiments, the plurality of the remote control mechanisms are arranged side by side in the horizontal direction. In other embodiments, the remote control mechanisms may alternatively be arranged up and down in the height direction. That is, a plurality of control assemblies 1 may be arranged side by side or arranged up and down. Correspondingly, a plurality of magnetic members 31 may be arranged side by side or arranged up and down according to required magnetic induction areas.

FIG. 5 shows an integrated design of the remote controller of the present disclosure and a spray pot 7. The spray pot 7 is integrated and arranged in the accommodating cavity 61. In combination with the working principle of the remote control mechanism, the remote controller can be used in cooperation with various receiving devices, such as a display screen, so as to control the display screen to execute corresponding commands by triggering the remote control through magnetic induction. The display screen may be an advertising screen, an entertainment screen for planting flowers and grass, etc. In some embodiments, the remote controller can be used to control the turning on and off of the advertising screen and the flower and the entertainment screen for planting flowers and grass. In some other embodiments, in addition to controlling the display screen to turn on and off, the remote controller further controls the display screen to display or switch different images according to different control signals. In other embodiments, the remote controller can also control the display screen to perform other functions, and details are not described herein.

The above-mentioned embodiments do not constitute a limitation on the protection scope of the technical solution. Any modifications, equivalent replacements and improvements made within the spirit and principles of the above-mentioned embodiments shall be included within the protection scope of this technical solution.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

What is claimed is:

1. A remote control mechanism, comprising:
a control assembly configured to generate a control signal;
a packaging assembly provided with a packaging space to receive the control assembly; and
a triggering assembly comprising a handle, a magnetic member, and a magnetic induction element, wherein the handle is rotatably connected to the packaging assembly, the magnetic member is mounted on the handle, and the magnetic induction element is provided in the packaging space and is electrically connected to the control assembly;
wherein the handle has a triggering position and an off position that are spaced apart, when the handle is located at the triggering position, the magnetic induction element is located out of a magnetic induction area of the magnetic member, and the control assembly generates the control signal; when the handle is switched to the off position, the magnetic induction element is located within the magnetic induction area of the magnetic member, and the control assembly stops generating the control signal.

2. The remote control mechanism according to claim 1, wherein the magnetic induction element comprises at least one of the group consisting of a Hall element, a coil, a reed switch, a semiconductor magnetoresistive element, and a magnetoresistive element.

3. The remote control mechanism according to claim 1, wherein the control assembly comprises a substrate, a microcontroller, and a signal transmitter that are provided in the packaging space, the microcontroller and the signal transmitter are both mounted on the substrate, the microcontroller is electrically connected to the signal transmitter, and the microcontroller is configured to control the signal transmitter to generate the control signal when the handle is located at the triggering position.

4. The remote control mechanism according to claim 3, further comprising an input power source mounted on the substrate, wherein the microcontroller and the signal transmitter are electrically connected to the input power source; or
wherein the microcontroller and the signal transmitter are electrically connected to an external DC power supply.

5. The remote control mechanism according to claim 1, wherein the packaging assembly comprises an upper cover and a lower base, the upper cover and the lower base enclose the packaging space, and the control assembly is detachably connected to the lower base.

6. The remote control mechanism according to claim 5, wherein a buckle is provided on a side of the upper cover facing the lower base, a side of the lower base facing the upper cover is provided with an engaging groove, and the buckle is engaged in the engaging groove.

7. The remote control mechanism according to claim 1, wherein the packaging assembly further comprises a sealing ring provided in the packaging space, the sealing ring is sleeved on the control assembly and is assembled in the packaging space in an interference fit.

8. The remote control mechanism according to claim 1, further comprising a reset member mounted on a side of the handle away from the magnetic induction element, wherein when the handle rotates from the off position to the triggering position, the reset member is compressed to enable the handle to have a tendency to rotate toward the off position.

9. A remote controller, comprising:
a housing provided with an accommodating cavity; and
the remote control mechanism according to claim 1, wherein the remote control mechanism is at least partially accommodated in the accommodating cavity, the packaging assembly is detachably connected to the housing, and at least a portion of the handle extends out of the accommodating cavity.

10. The remote controller according to claim 9, wherein the remote controller comprises a plurality of remote control mechanisms, and the plurality of remote control mechanisms are arranged side by side or arranged up and down.
